(19) United States
(12) Patent Application Publication
(10) Pub. No.: US 2015/0302806 A1
(43) Pub. Date: Oct. 22, 2015

(54) IMAGE-DISPLAY APPARATUS AND CONTROL METHOD THEREOF

(71) Applicant: CANON KABUSHIKI KAISHA, Tokyo (JP)

(72) Inventor: Mitsuru Tada, Machida-shi (JP)

(21) Appl. No.: 14/687,800

(22) Filed: Apr. 15, 2015

(30) Foreign Application Priority Data
Apr. 17, 2014 (JP) 2014-085476

(51) Int. Cl. G09G 3/34

(52) U.S. Cl. CPC G09G 3/3413; G09G 2340/16; G09G 2320/0295

(57) ABSTRACT

An image-display apparatus according to the present invention, includes: a light emission unit; a display unit configured to display an image on a screen by transmitting light emitted from the light emission unit, wherein the display unit includes: a first panel configured to transmit the light emitted from the light emission unit at transmittance based on a time change of brightness of input image data; and a second panel configured to transmit, at transmittance corresponding to the input image data, the light transmitted through the first panel at transmittance corresponding to the input image data.

### BACKGROUND OF THE INVENTION

1. Field of the Invention

The present invention relates to an image-display apparatus and a control method thereof.

2. Description of the Related Art

As a technique that improves the response speed of liquid-crystal elements of a liquid-crystal display, overdriving is known. The overdriving is a technique that temporarily applies a drive signal larger (or smaller) than a drive signal (a voltage or current) corresponding to input image data to the liquid-crystal elements. The response speed of the liquid-crystal elements is the period of time after the drive signal is applied to the liquid-crystal elements until the desired transmittance is obtained.

A related art reference of the overdriving is disclosed for example in Japanese Patent Application publication No. H10-39837.

In the technique disclosed in Japanese Patent Application publication No. H10-39837, the value of the drive signal (drive value) that represents the present frame of input image data is determined based on the gradation values of an earlier frame and a later frame of the input image data. The present frame is a frame that occurs at the present time. The earlier frame is a frame immediately preceding the present frame. The later frame is a frame immediately following the present frame.

However, in the technique disclosed in Japanese Patent Application publication No. H10-39837, the dynamic range of a display image (an image that appears on a screen) may decrease. Specifically, in the technique disclosed in Japanese Patent Application publication No. H10-39837, a value in the range of drive values corresponding to the range of gradation values that the input image data can have are determined as a drive value of the overdriving. Thus, to overdrive all the gradation values, the range of the gradation values that the input image data can have needs to be narrowed. However, if the range of the gradation values that the input image data can have is narrowed, the dynamic range of the display image decreases.

Assuming that the gradation values and drive values are 8-bit values (0 to 255), if all the gradation values are overdriven, the range of gradation values of the input image data needs to be narrowed from a range of 0-255 to a range of 32-220. However, if the range of the gradation values is narrowed from 0-255 to 32-220, the dynamic range of the display image decreases.

If the range of the gradation values that the input image data may exhibit is not narrowed, since part of the gradation values is not overdriven, the image quality of the display image may deteriorate.

### SUMMARY OF THE INVENTION

The present invention provides a technique that can obtain a desired display image in a short time without a tradeoff of a decrease of the dynamic range of display image.

The present invention in its first aspect provides an image-display apparatus, comprising:

a light emission unit;

a display unit configured to display an image on a screen by transmitting light emitted from the light emission unit, wherein

the display unit includes:

a first panel configured to transmit the light emitted from the light emission unit at transmittance based on a time change of brightness of input image data; and

a second panel configured to transmit, at transmittance corresponding to the input image data, the light transmitted through the first panel.

The present invention in its second aspect provides a control method for an image-display apparatus having a light emission unit; a first panel configured to transmit light emitted from the light emission unit; and a second panel configured to display an image on a screen by transmitting the light transmitted through the first panel,

the method comprising:

a first step of controlling the transmittance of the first panel at transmittance based on a time change of the brightness of input image data; and

a second step of controlling the transmittance of the second panel at transmittance based on the input image data.

According to the present invention, a desired display image can be obtained in a short time without a tradeoff of a decrease of the dynamic range of a display image.

Further features of the present invention will become apparent from the fol1owing de script ion of exemplary embodiments with reference to the attached drawings.

### BRIEF DESCRIPTION OF THE DRAWINGS

FIG. 1 is a block diagram showing an example of a structure of an image-display apparatus according to embodiment 1 of the present invention;

FIG. 2 is a flow chart showing an example of an operation of the image-display apparatus according to embodiment 1;

FIG. 3 is a schematic diagram showing an example of correspondence information according to embodiment 1;

FIG. 4A and FIG. 4B are graphs showing an example of an effect of embodiment 1;

FIG. 5 is a block diagram showing an example of a structure of an image-display apparatus according to embodiment 2 of the present invention;

FIG. 6 is graphs showing an example of an effect of embodiment 2; and

FIG. 7 is a block diagram showing an example of a structure of an image-display apparatus according to embodiment 3 of the present invention.

### DESCRIPTION OF THE EMBODIMENTS

### Embodiment 1

Next, an image-display apparatus and a control method according to embodiment 1 of the present invention will be described.

The image-display apparatus according to the present embodiment will be described as for example a transmissive liquid-crystal display apparatus in the following. However, the image-display apparatus according to the present embodiment is not limited to a transmissive liquid-crystal display apparatus as long as the image-display apparatus displays an image on a screen by transmitting light emitted from a light source. For example, the image-display apparatus may be a Micro-Electro Mechanical System (MEMS)-shutter display that uses an MEMS shutter instead of liquid-crystal elements.

(Structure)

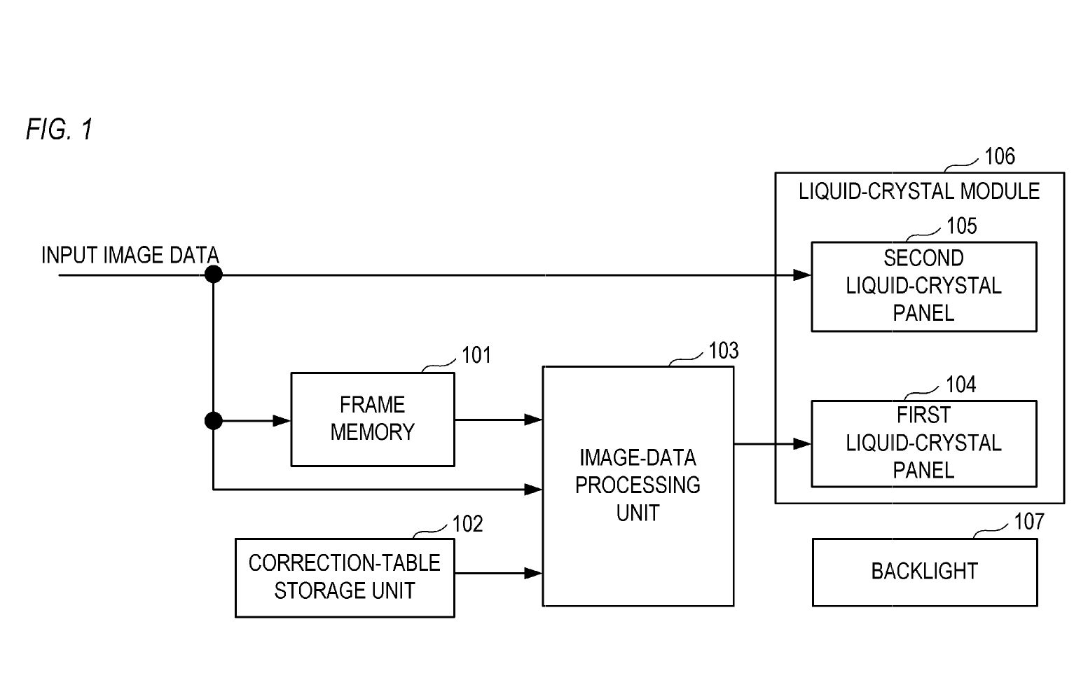

Next, with reference to FIG. 1, a structure of the image-display apparatus according to the present embodiment will be described.

FIG. 1 is a block diagram showing an example of the structure of the image-display apparatus according to the present embodiment. As shown in FIG. 1, the image-display apparatus according to the present embodiment includes a frame memory 101, a correction-table storage unit 102, an image-data processing unit 103, a liquid-crystal module 106, a backlight 107, and so forth.

The backlight 107 is a light-emission unit that irradiates a rear surface of the liquid-crystal module 106 (specifically, a first liquid-crystal panel that will be described later) with light.

The liquid-crystal module 106 is a display unit that displays an image on a screen by transmitting light emitted from the backlight 107. As shown in FIG. 1, the liquid-crystal module 106 has a first liquid-crystal panel 104 and a second liquid-crystal panel 105.

The first liquid-crystal panel 104 is a first panel that transmits light emitted from the backlight 107 with the transmittance based on a time change of the brightness of the input image data.

The second liquid-crystal panel 105 is a second panel that transmits, with the transmittance corresponding to the input image data, light transmitted through the first liquid-crystal panel 104.

The frame memory 101 isastorageunitthat stores input image data of one frame. The frame memory 101 delays the input image data for a period of time corresponding to one frame and outputs the delayed data to the image-data processing unit 103. Specifically, input image data of the present frame is input to the frame memory 101. The frame memory 101 outputs input image data of a frame that immediately precedes the present frame to the image-data processing unit 103.

The correction-table storage unit 102 is a recording medium such as a semiconductor memory, a magnetic disc, an optical disc, or the like. Relationship information that relates to the correspondence between change amounts of brightness and transmittance is pre-recorded to the correction-table storage unit 102.

The image-data processing unit 103 determines the transmittance of the first liquid-crystal panel 104 based on a time change of the brightness of the input image data (first determination process).

Specifically, if the brightness of the input image data does not change, the image-data processing unit 103 determines the reference value of the transmittance as the transmittance of the first liquid-crystal panel 104. If the brightness of the input image data increases, the image-data processing unit 103 determines a value larger than the reference value as the transmittance of the first liquid-crystal panel 104. In contrast, if the brightness of the input image data decreases, the image-data processing unit 103 determines a value smaller than the reference value as the transmittance of the first liquid-crystal panel 104.

The reference value may be a value predetermined by the manufacturer or a value that can be changed by the user. The image-display apparatus may have for example a determination unit that executes a process that determines the reference value corresponding to the brightness of the whole screen that the user inputs (fourth determination process).

According to the present embodiment, the input image data of the present frame and the input image data of the immediately preceding frame are input to the image-data processing unit 103. In addition, the image-data processing unit 103 obtains the correspondence information from the correction-table storage unit 102. Moreover, the image-data processing unit 103 determines the transmittance of the first liquid-crystal panel 104 for the present frame corresponding to the brightness of the input image data of the present frame, the brightness of the input image data of the immediately preceding frame, and the correspondence information. According to the present embodiment, the amount of change of the brightness of the input image data from the immediately preceding frame to the present frame is used as the value of time change of the brightness of the input image data.

The determination method for determining a time change of the brightness of the input image data is not limited to the foregoing method. Alternatively, the time change of the brightness of the input image data may be determined based on the immediately preceding frame and the immediately following frame instead of the present frame and the immediately preceding frame. Further alternatively, the time change of the brightness of the input image data may be determined based on input image data three or more frames.

According to the present embodiment, gradation values are input to the first liquid-crystal panel 104 and the second liquid-crystal panel 105. The first liquid-crystal panel 104 and the second liquid-crystal panel 105 control the transmittance corresponding to the input gradation values. The image-data processing unit 103 determines the gradation value corresponding to the transmittance of the first liquid-crystal panel.

(Operation)

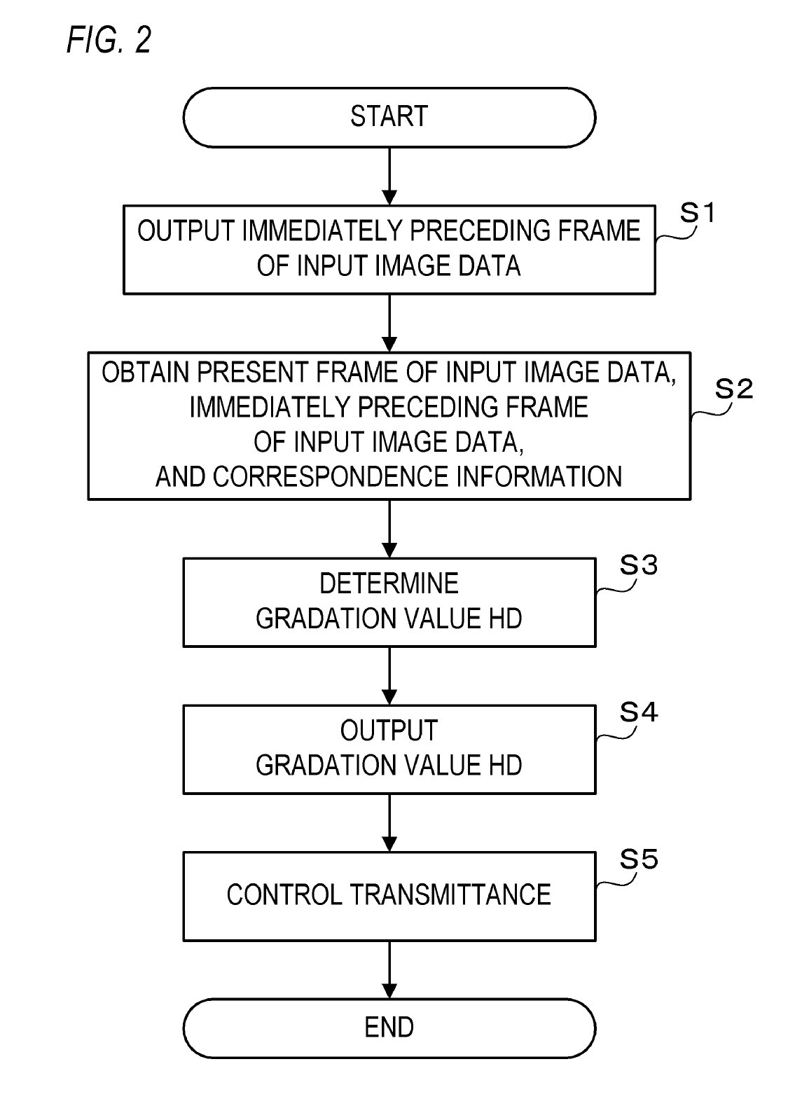

Next, with reference to FIG. 2, an operation of the image-display apparatus according to the present embodiment will be described.

FIG. 2 is a flow chart showing an example of the operation of the image-display apparatus according to the present embodiment. Specifically, the flow chart shown in FIG. 2 shows an operation that is performed after input image data is input to the image-display apparatus until the transmittance of the first liquid-crystal panel 104 is controlled.

In the following, an example of the case that the gradation values of the input image data and drive signal values (drive values) with which the first liquid-crystal panel 104 and the second liquid-crystal panel 105 control the transmittance are 8-bit values (0 to 255) will be described. In the following, an example of the case that the brightness and transmittance become a larger value as the gradation value is larger will be described.

The ranges of the gradation values and drive values are not limited to the foregoing ranges. Alternatively, the number of bits of each of the gradation values and drive values may be larger than or smaller than 8 bits.

In addition, the correspondence of the gradation values to the brightness and transmittance is not limited to the foregoing range. The brightness may become a smaller value as the gradation value is larger. The transmittance may become a smaller value as the gradation value is larger.

First, the frame memory 101 obtains the input image data of the present frame and outputs the input image data of the immediately preceding frame to the image-data processing unit 103 (at S1).

Thereafter, the image-data processing unit 103 obtains the input image data of the present frame, the input image data of the immediately preceding frame, and the correspondence information (at S2).

Thereafter, the image-data processing unit 103 determines the gradation value corresponding to the transmittance of the first liquid-crystal panel 104 of the present frame (at S3). The first liquid-crystal panel 104 and the second liquid-crystal panel 105 can control the transmittance for each pixel of the input image data. Specifically, the first liquid-crystal panel 104 and the second liquid-crystal panel 105 have liquid-crystal elements corresponding to pixels of the input image data. The first liquid-crystal panel 104 and the second liquid-crystal panel 105 control the transmittance of the liquid-crystal element for each pixel of the input image data. At S3, the gradation value is determined for each pixel of the input image data.

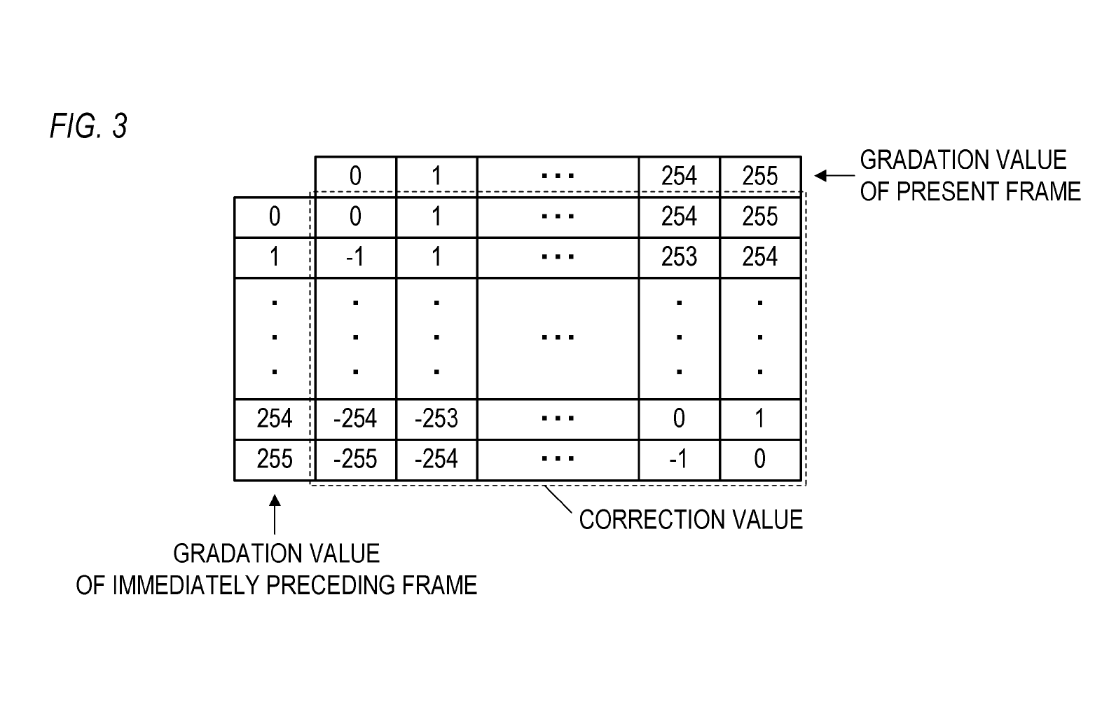

According to the present embodiment, table data shown in FIG. 3 is provided as the correspondence information.

The table data shown in FIG. 3 represents a correction value that corrects the reference gradation value (a gradation value corresponding to a reference value) for each combination of gradation values that the input image data of the present frame can have and the gradation values that the input image data of the immediately preceding frame can have. In the example shown in FIG. 3, the correction value is an addition value added to the reference gradation value.

The image-data processing unit 103 obtains the correction value corresponding to the combination of the gradation value of the input image data of the present frame and the gradation value of the input image data of the immediately preceding frame from the table data shown in FIG. 3. Thereafter, the image-data processing unit 103 adds the obtained correction value to the reference value so as to calculate a gradation value HD corresponding to the transmittance of the first liquid-crystal panel 104 of the present frame. However, if the value of which the correction value is added to the reference value exceeds the upper limit value of the gradation value, the upper limit value is set as the gradation value HD. In contrast, if the value of which the correction value is added to the reference value becomes lower than the lower limit value of the gradation value, the lower limit value is set as the gradation value HD.

With respect to the table data shown in FIG. 3, the larger the value of which the gradation value that the input image data of the immediately preceding frame can have is subtracted from the gradation value that the input image data of the present frame can have is, the larger the correction value becomes. Thus, according to the present embodiment, if the brightness of the input image data increases from the immediately preceding frame to the present frame, it is determined that the transmittance of the first liquid-crystal panel 104 for the present frame to be a larger value as amount of increase of the brightness is larger. If the brightness of the input image data decreases from the immediately preceding frame to the present frame, it is determined that the transmittance of the first liquid-crystal panel 104 for the present frame to be a smaller value as amount of decrease of the brightness is larger.

The correspondence information is not limited to the table data shown in FIG. 3. For example, the correspondence information may be a function that represents the correspondence of the brightness that the input image data of the present frame can have, the brightness that the input image data of the immediately preceding frame can have, and the correction value. Alternatively, the correspondence information may be a table or a function that represents the correspondence of the brightness difference that can be had (a candidate of the difference of the brightness of the input image data of the present frame data and the brightness of the input image data of the immediately preceding frame) and the correction value.

According to the present embodiment, an example of the case that the reference value is corrected so as to determine the transmittance of the first liquid-crystal panel 104 is described. However, the method for determining the transmittance is not limited. For example, the correspondence information may represent the gradation value HD instead of the correction value.

Alternatively, time-differentiation of the brightness of the input image data may be performed so as to determine the transmittance of the first liquid-crystal panel 104 based on a result of the time-differentiation. In this case, a function or a table that represents the correspondence of the result of the time-differentiation and the transmittance of the first liquid-crystal panel 104 maybe used. The time-differentiation can be performed by using the brightness of the input image data of each of a plurality of frames. For example, the time-differentiation can be performed by using the brightness of the input image data of each of the present frame and the immediately preceding frame. Alternatively, the time-differentiation can be performed by using the brightness of the input image data of each of the present frame and the following frame (the frame immediately following the present frame). Further alternatively, the time-differentiation can be performed by using the brightness of the input image data of each of the present frame, the immediately preceding frame, and the immediately following frame.

The transmittance (gradation value HD) of the first liquid-crystal panel 104 for the present frame can be calculated based on for example Formula 1 that follows. In Formula 1, “Dnow” is the brightness (gradation value) of the input image data of the present frame; “Dold” is the brightness of the input image data of the immediately preceding frame; and “α” is a coefficient. “Dnow−Dold” equals to what the time-differentiation of the brightness of the input image data. The coefficient a is a conversion coefficient with which the result of the time-differentiation is converted into the gradation value HD and that depends on the characteristics of the liquid-crystal panel.

HDmn=(Dnow−Dold)×α Formula 1

Next to S3, the image-data processing unit 103 outputs the transmittance (gradation value HD) determined at S3 to the first liquid-crystal panel 104 (at S4). Specifically, the image-data processing unit 103 outputs the gradation value HD of each pixel.

Thereafter, the first liquid-crystal panel 104 controls, corresponding to the gradation value HD, the transmittance of each of the liquid-crystal elements corresponding to the pixels (at S5). In addition, in synchronization with this process, the second liquid-crystal panel 105 controls the transmittance of each of the liquid-crystal elements corresponding to the input image data.

(Effect)

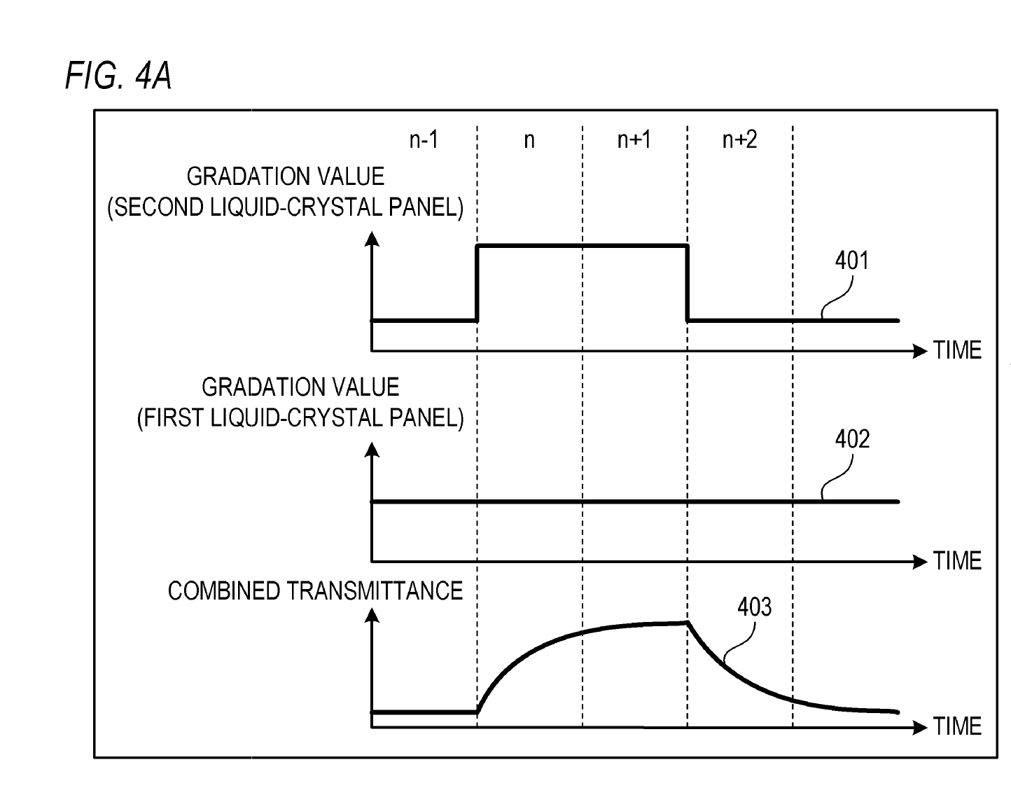

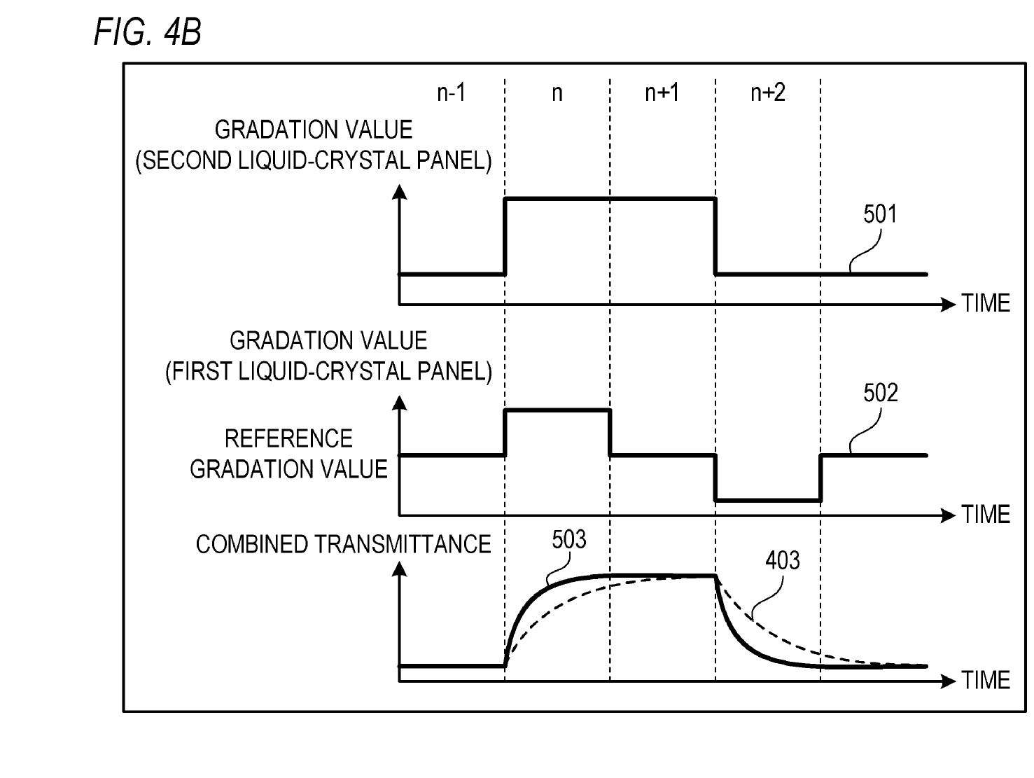

Next, with reference to FIGS. 4A and 4B, an effect of the present embodiment will be described.

First, with reference to FIG. 4A, a related art reference will be described.

In FIG. 4A, reference numeral 401 is a gradation value of input image data (a gradation value that is input to a second liquid-crystal panel 105); reference numeral 402 is a gradation value HD that is input to a first liquid-crystal panel 104. In the related art reference, the first liquid-crystal panel 104 is not used. Thus, in FIG. 4A, the gradation value 402 that is input to the first liquid-crystal panel 104 is a constant value (a reference gradation value). In other words, in FIG. 4A, the transmittance of the first liquid-crystal panel 104 is a constant value (a reference value). Reference numeral 403 is the combined transmittance of which the transmittance of the first liquid-crystal panel 104 and the transmittance of the second liquid-crystal panel 105 are combined. The combined transmittance corresponds to display brightness (the brightness of a screen).

Generally, when the gradation value changes, the electric field changes. The transmittance of each of the liquid-crystal elements of the liquid-crystal panel changes with a delay. Specifically, as the electric field changes, the orientations of molecules of the liquid crystal change with a delay because of the viscosity of the liquid crystal.

Thus, as shown in FIG. 4A, if the gradation value 401 of the input image data increases stepwise from the (n−1)th frame to the n-th frame, the combined transmittance 403 increases with a delay. In other words, the combined transmittance 403 slowly increases.

In addition, as shown in FIG. 4A, if the gradation value 401 of the input image data decreases stepwise from the (n+1)th frame to the (n+2)-th frame, the combined transmittance 403 decreases with a delay. In other words, the combined transmittance 403 slowly decreases.

As described above, according to the related art reference, since the combined transmittance 403 slowly changes, a desired display image cannot be obtained with high response. In other words, a desired display image cannot be obtained in a short time.

Next, with reference to FIG. 4B, the present embodiment will be described.

In FIG. 4B, reference numeral 501 is a gradation value of the input image data (a gradation value that is input to the second liquid-crystal panel 105); and reference numeral 502 is a gradation value HD that is input to the first liquid-crystal panel 104. For comparison, the value of the gradation value 501 is the same as the value of the gradation value 401. Reference numeral 503 is the combined transmittance of which the transmittance of the first liquid-crystal panel 104 and the transmittance of the second liquid-crystal panel 105 are combined.

According to the present embodiment, as shown in FIG. 4B, if the gradation value 501 of the input image data increases stepwise from the (n−1)th frame to the n-th frame, a gradation value larger than the reference gradation value is set for the gradation value 502 (gradation value HD). As a result, the combined transmittance 503 increases more quickly than the combined transmittance 403.

In contrast, according to the present embodiment, as shown in FIG. 4B, if the gradation value 501 of the input image data decreases stepwise from the (n+1)-th frame to the (n+2)-th frame, a gradation value smaller than the reference gradation value is set for the gradation value 502 (gradation value HD). As a result, the combined transmittance 503 decreases more quickly than the combined transmittance 403.

As described above, according to the present embodiment, the transmittance of the first liquid-crystal panel 104 is controlled to transmittance based on a time change of the brightness of the input image data. Thus, the speed at which the combined transmittance changes can be increased in comparison with that according to the related art reference. As a result, a desired display image can be obtained with a good response. In other words, a desired display image can be obtained in a short time. In addition, according to the present embodiment, the transmittance of the second liquid-crystal panel 105 is controlled corresponding to the input image data without need to narrow the range of gradation values that the input image data can have. Asa result, according to the present embodiment, a desired display image can be obtained in a short time without a tradeoff of a decrease of the dynamic range of the display image.

According to the present embodiment, an example of the case that the transmittance of the first liquid-crystal panel 104 changes corresponding to the amount of change of the brightness of the input image data is described. However, the present embodiment is not limited to such a case. In other words, according to the present embodiment, the transmittance of the first liquid-crystal panel 104 is controlled to transmittance based on a time change of the brightness of the input image data. For example, if the brightness of the input image data increases, a first value larger than the reference value may be determined as the transmittance of the first liquid-crystal panel 104 regardless of the increase amount of the brightness. In contrast, if the brightness of the input image data decreases, a second value smaller than the reference value maybe determined as the transmittance of the first liquid-crystal panel 104 regardless of the decrease amount of the brightness. However, if a value that depends on the amount of change of the brightness of the input image data is determined as the transmittance of the first liquid-crystal panel 104, a desired display image can be securely obtained in a short time.

### Embodiment 2

Next, an image-display apparatus and a control method according to embodiment 2 of the present invention will be described. According to the present embodiment, an example of the case that a first liquid-crystal panel 104 is driven at a frequency n times higher than the frame rate of input image data (where n is an integer equal to or greater than 2) will be described.

(Structure)

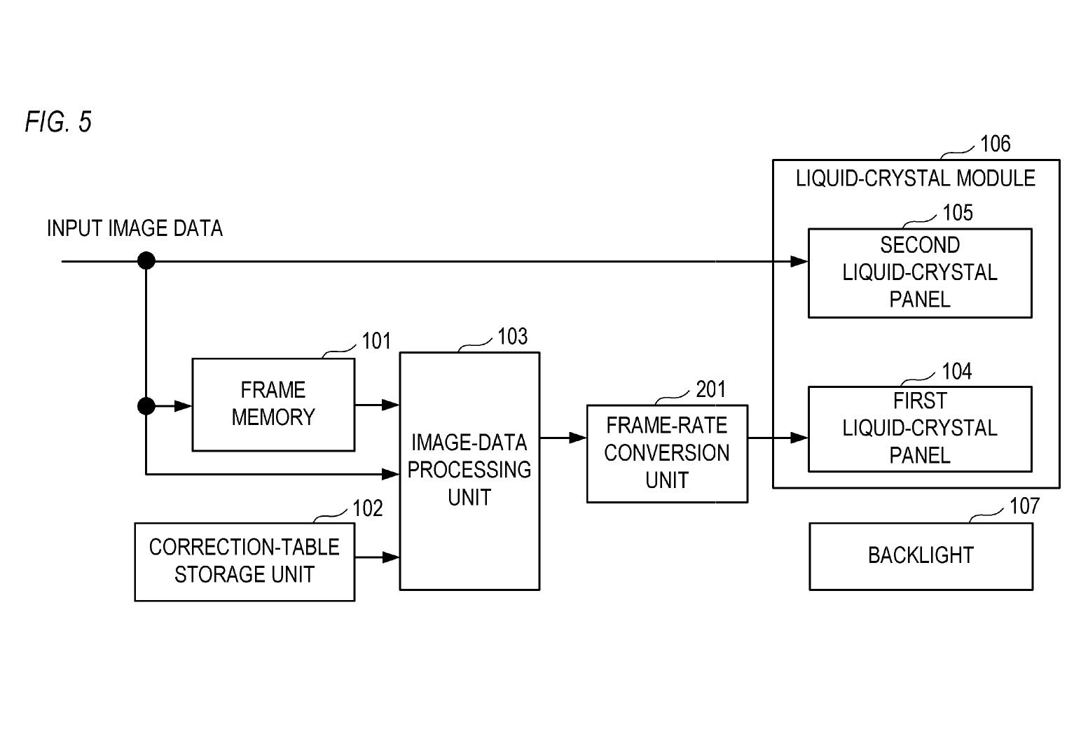

With reference to FIG. 5, a structure of the image-display apparatus according to the present embodiment will be described.

FIG. 5 is a block diagram showing an example of the structure of the image-display apparatus according to the present embodiment. As shown in FIG. 5, the image-display apparatus according to the present embodiment also includes a frame-rate conversion unit 201 along with the functional units of embodiment 1 (FIG. 1).

In FIG. 5, similar functional units to those in FIG. 1 are represented by similar reference numerals and their description will be omitted.

An image-data processing unit 103 outputs a determined gradation value (the transmittance of a first liquid-crystal panel 104) to a frame-rate conversion unit 201.

The frame-rate conversion unit 201 outputs the gradation value to the first liquid-crystal panel 104 at a frequency n times higher than the frame rate of the input image data (where n is an integer equal to or greater than 2). Specifically, the frame-rate conversion unit 201 determines the gradation values of n divided periods that constitute the period of the present frame of the input image data and outputs the determined gradation values to the first liquid-crystal panel 104. The gradation values of the n divided periods are determined based on the gradation value that the image-data processing unit 103 determines for the present frame. In other words, the frame-rate conversion unit 201 determines the transmittance of the first liquid-crystal panel 104 for each of the n divided periods that constitute the period of the present frame of the input image data based on the transmittance that the image-data processing unit 103 determines for the present frame (second determination process). Thereafter, the frame-rate conversion unit 201 outputs the determined gradation values of the divided periods to the first liquid-crystal panel 104. As a result, the first liquid-crystal panel 104 is driven at a frequency n times higher than the frame rate of the input image data.

(Effect)

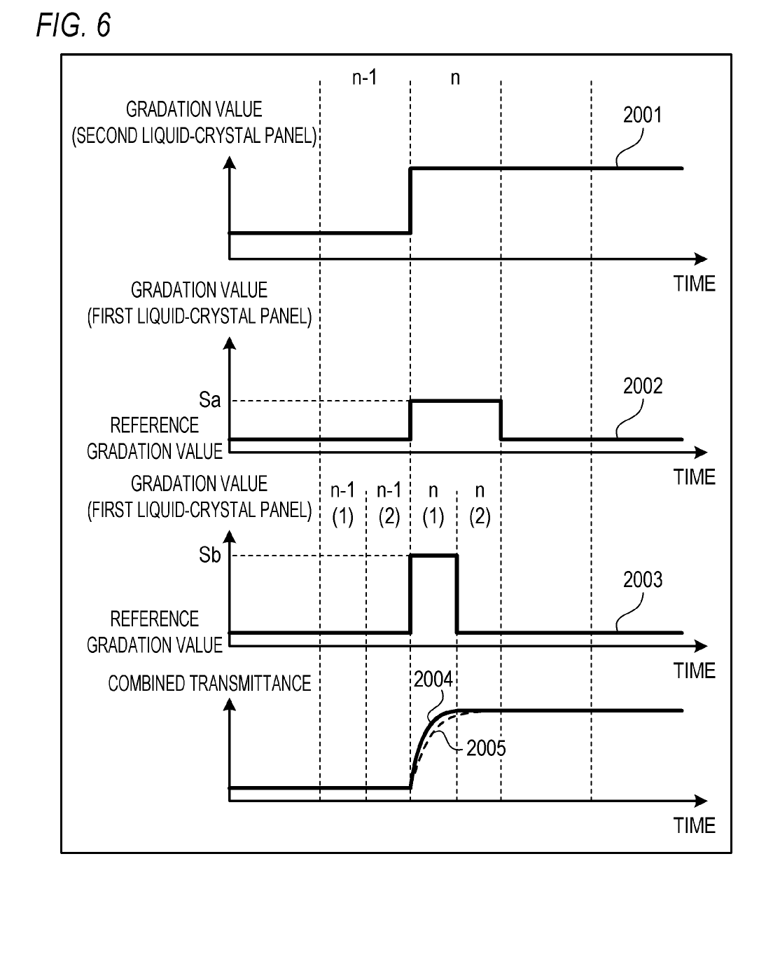

Next, with reference to FIG. 6, an effect of the present embodiment will be described.

In FIG. 6, reference numeral 2001 is a gradation value of the input image data (a gradation value that is input to a second liquid-crystal panel 105). In the example shown in FIG. 6, the gradation value 2001 increases stepwise from the (n−1)-th frame to the n-th frame.

Reference numeral 2002 is a gradation value that is input to the first liquid-crystal panel 104 when driven according to embodiment 1. Since the gradation value 2001 of the input image data increases stepwise from the (n−1)th frame to the n-th frame, a gradation value Sa that is larger than a reference gradation value is set for the n-th frame.

Reference numeral 2005 is the combined transmittance at which the first liquid-crystal panel 104 is driven with the gradation value 2002.

Reference numeral 2003 is a gradation value that is input to the first liquid-crystal panel 104 when driven according to the present embodiment. In FIG. 6, (x) written along with a frame number (where x is an integer that is equal to or greater than 1 and equal to or smaller than n) is the order of n divided periods (time position) that constitute the period of one frame of the input image data. In the example shown in FIG. 6, the period of one frame of the input image data is constituted by two divided periods.

Reference numeral 2004 is the combined transmittance at which the first liquid-crystal panel 104 is driven with the gradation value 2003.

As described above, according to the present embodiment, the gradation values of the first liquid-crystal panel 104 for the n divided periods are determined based on the gradation value that the image-data processing unit 103 determines for the present frame.

In the example shown in FIG. 6, if the gradation value of the input image data does not change, like embodiment 1, the reference gradation value is determined as the gradation value of the first liquid-crystal panel 104 for two divided periods that constitute the period of the present frame.

If gradation values of the input image data change, a gradation value that has a larger difference from the reference gradation value than the gradation value that the image-data processing unit 103 determines for the present frame is determined as a gradation value of an earlier divided period of the two divided periods. In other words, if the brightness of the input image data changes, the transmittance that has a larger difference from the transmittance than the transmittance that the image-data processing unit 103 determines for the present frame is determined as the transmittance for an earlier divided period of the two divided periods. The reference gradation value is determined as the gradation value of the first liquid-crystal panel 104 in a later divided period of the two divided periods. In other words, the reference value is determined as the transmittance of the first liquid-crystal panel 104 in a later divided period of the two divided periods. In the example shown in FIG. 6, as the gradation value of the first liquid-crystal panel 104 in an earlier divided period of the two divided periods that constitute the n-th frame, a gradation value Sb larger than the gradation value Sa is set. In addition, as the gradation value of the first liquid-crystal panel 104 in a later divided period of the two divided periods that constitute the n-th frame, the reference gradation value is set. If the gradation value of the input image data decreases from the (n−1)-th frame to the n-th frame, as the gradation value of the first liquid-crystal panel 104 in the earlier divided period of the two divided periods that constitute the n-th frame, a gradation value that is smaller than the gradation value that the image-data processing unit 103 determines is set.

According to the present embodiment, since the gradation values of the individually divided periods are determined, the speed at which the combined transmittance changes becomes higher than that according to embodiment 1 as represented by the combined transmittances 2004 and 2005 of FIG. 6.

As described above, according to the present embodiment, the transmittance of the first liquid-crystal panel 104 in each of the n divided periods that constitute the period of the present frame of the input image data is determined based on the transmittance that the image-data processing unit 103 determines for the present frame. Thus, according to the present embodiment, the speed at which the combined transmittance changes becomes higher than that according to embodiment 1. As a result, the display response of an image according to the present embodiment becomes higher than that according to embodiment 1. In other words, according to the present embodiment, a desired display image can be obtained in a shorter time than embodiment 1.

According to the present embodiment, an example of the case of n=2 is described. Alternatively, n may be 3 or greater. In this case, the transmittance that has a larger difference from the reference value than the transmittance that the image-data processing unit determines is set for the earliest one of n divided periods that constitute the period of the present frame, whereas the reference value is set for the (n−1) divided periods. Alternatively, the transmittance that has a larger difference from the reference value than the transmittance that the image-data processing unit determines for the present frame is set for the first m divided periods (where m is an integer smaller than n) of the n divided periods, whereas the reference value is set for the (n−m) divided periods. The method for setting the transmittance in the m divided periods is not limited. For example, the transmittance may be set for them divided periods so that the difference from the reference value gradually decreases.

### Embodiment 3

Next, an image-display apparatus and a control method according to embodiment 3 of the present invention will be described. According to the present embodiment, an example of the case that the resolution of a first liquid-crystal panel 104 is lower than that of a second liquid-crystal panel 105 will be described.

(Structure)

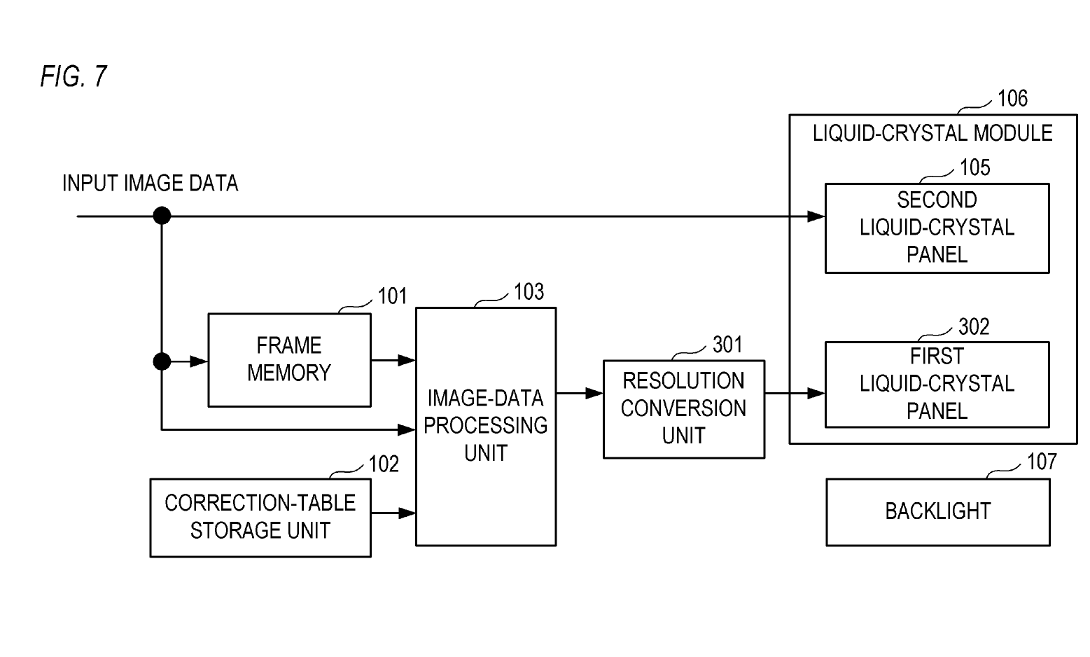

With reference to FIG. 7, a structure of the image-display apparatus according to the present embodiment will be described.

FIG. 7 is a block diagram showing an example of the structure of the image-display apparatus according to the present embodiment. As shown in FIG. 7, the image-display apparatus according to the present embodiment also includes a resolution-conversion unit 301 along with the functional units according to embodiment 1 (FIG. 1).

The resolution of a first liquid-crystal panel according to the present embodiment is different from that of the first liquid-crystal panel 104 shown in FIG. 1. Thus, the first liquid-crystal panel according to the present embodiment is represented with reference numeral 302.

In FIG. 7, similar functional units to those in FIG. 1 are represented by similar reference numerals and their description will be omitted.

The second liquid-crystal panel 105 has the resolution that allows the transmittance for each pixel of input image data to be controlled. Specifically, the second liquid-crystal panel 105 has liquid-crystal elements corresponding to pixels of the input image data.

The first liquid-crystal panel 302 has the resolution lower than the second liquid-crystal panel 105. The second liquid-crystal panel 105 has the resolution that allows the transmittance of each of the pixels of the input image data to be controlled. Specifically, the second liquid-crystal panel 105 has liquid-crystal elements corresponding to the pixels of the input image data. The first liquid-crystal panel 302 has the resolution that allows transmittance of each of a plurality of divided regions that constitute a region of an image of the input image data to be individually controlled. Specifically, the first liquid-crystal panel 302 has liquid-crystal elements corresponding to the divided regions. Each of the divided regions is constituted by a plurality of pixels of the input image data.

An image-data processing unit 103 outputs gradation values of individual pixels (the transmittance of the first liquid-crystal panel 302) to a resolution-conversion unit 301.

The resolution-conversion unit 301 converts the resolution of image data that is output from the image-data processing unit 103 (image data in which gradation values of individual pixels are the gradation value HD) corresponding to the resolution of the first liquid-crystal panel 302. In other words, the resolution-conversion unit 301 determines gradation values (transmittance) of the individually divided regions of the first liquid-crystal panel 302 based on gradation values of individual pixels (the transmittance of the first liquid-crystal panel 302) that are output from the image-data processing unit 103 (third determination process).

For example, the resolution-conversion unit 301 determines, for each divided region, a representative value that represents a plurality of gradation values determined for a plurality of pixels of the divided region as a gradation value of the divided region. The representative value is for example an average value, a maximum value, a minimum value, a mode, a median, or the like.

The resolution-conversion unit 301 outputs image data whose resolution has been converted (gradation values of individually divided regions) to the first liquid-crystal panel 302.

As a result, the first liquid-crystal panel 302 can control the transmittance of each of the divided regions corresponding to the gradation values that are output from the resolution-conversion unit 301.

(Effect)

Next, an effect of the present embodiment will be described.

If the resolution of the second liquid-crystal panel 105 is 300 dpi, the resolution of the first liquid-crystal panel 302 has to be lower than 300 dpi.

If the resolution of the first liquid-crystal panel 302 is 100 dpi, the ratio of the total number of liquid-crystal elements of the first liquid-crystal panel 302 to that of the second liquid-crystal panel 105 is 1 to 9. If the resolution of the second liquid-crystal panel 105 is full HD (1920 pixels in horizontal direction×1080 pixels in vertical direction), the resolution of the first liquid-crystal panel 302 becomes 640 pixels×360 pixels. In this case, the transmittance of the first liquid-crystal panel 302 can be controlled for each divided region smaller than a compressed block according to MPEG4, MPEG2, or the like, and the display response of an image can be improved. In MPEG4, since each of 8 regions in horizontal direction×8 regions in vertical direction that constitute a region of an image is used as a compressed block, the size of the compressed block is approximately 240 pixels in horizontal direction×135 pixels in vertical direction. In MPEG2, since each of 16 regions×16 regions that constitute a region of an image is used as a compressed block, the size of the compressed block is approximately 120 pixels×68 pixels.

If the resolution of the first liquid-crystal panel 302 is 1 dpi, the ratio of the total number of liquid-crystal elements of the first liquid-crystal panel 302 to the total number of liquid-crystal elements of the second liquid-crystal panel 105 is 1 to 900. If the resolution of the second liquid-crystal panel 105 is full HD, the resolution of the first liquid-crystal panel 302 becomes approximately 7 pixels×4 pixels. In this case, the display response of an image can be improved to some extent.

As described above, according to the present embodiment, the transmittance of each divided region of the first liquid-crystal panel 302 is determined based on the transmittance that the image-data processing unit 103 determines (the transmittance of the first liquid-crystal panel 302 of each pixel). As a result, the transmittance of each divided region of the first liquid-crystal panel 302 can be properly controlled.

Although the transmittance of the first liquid-crystal panel 302 of each pixel cannot be controlled, since the structure of the first liquid-crystal panel 302 can be simplified, the manufacturing cost and manufacturing time can be reduced.

If a liquid-crystal panel having low resolution is manufactured, since the aperture of the liquid-crystal panel can be easily improved, the upper limit value of the transmittance of the first liquid-crystal panel 302 can be improved. Thus, the upper limit value of the display brightness can be improved.

The divided regions may be determined in any manner. For example, if local dimming that controls the brightness of a backlight of each of a plurality of light emission regions that constitute a screen is performed, the light emission regions may be used as divided regions. A region larger or smaller than a light emission region may be used as a divided region.

As in embodiment 2, the drive frequency of the first liquid-crystal panel may be changed. In this case, the frame-rate conversion unit may be disposed upstream or downstream of the resolution-conversion unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-085476, filed on Apr. 17, 2014, which is hereby incorporated by reference herein in its entirety.

What is claimed is:

1. An image-display apparatus, comprising:
a light emission unit;
a display unit configured to display an image on a screen by transmitting light emitted from the light emission unit, wherein
the display unit includes:
a first panel configured to transmit the light emitted from the light emission unit at transmittance based on a time change of brightness of input image data; and
a second panel configured to transmit, at transmittance corresponding to the input image data, the light transmitted through the first panel.

2. The image-display apparatus according to claim 1, further comprising:
a first determination unit configured to determine the transmittance of the first panel based on the time change of the brightness of the input image data, wherein
the first determination unit determines a reference value of the transmittance as the transmittance of the first panel when the brightness of the input image data does not change,
the first determination unit determines a value larger than the reference value as the transmittance of the first panel when the brightness of the input image data increases, and
the first determination unit determines a value smaller than the reference value as the transmittance of the first panel when the brightness of the input image data decreases.

3. The image-display apparatus according to claim 2, wherein
when the brightness of the input image data increases from a frame immediately preceding a present frame to the present frame, the first determination unit determines the transmittance of the first panel for the present frame to be a larger value as amount of increase of the brightness is larger, and
when the brightness of the input image data decreases from the immediately preceding frame to the present frame, the first determination unit determines the transmittance of the first panel for the present frame to be a smaller value as amount of decrease of the brightness is larger.

4. The image-display apparatus according to claim 2, wherein
correspondence information that relates to the correspondence between an amount of change of the brightness and the transmittance is provided in advance, and
the first determination unit determines the transmittance of the first panel for the present frame based on the brightness of the input image data of the frame immediately preceding the present frame, the brightness of the input image data of the present frame, and the correspondence information.

5. The image-display apparatus according to claim 2,
wherein the first determination unit performs the time-differentiation of the brightness of the input image data and determines the transmittance of the first panel corresponding to a result of the time-differentiation.

6. The image-display apparatus according to claim 3, further comprising:
a second determination unit configured to determine the transmittance of the first panel for each of n divided periods (where n is an integer equal to or greater than 2) that constitute a period of the present frame of the input image data, based on the transmittance determined for the present frame by the first determination unit.

7. The image-display apparatus according to claim 6, wherein
when the brightness of the input image data changes, the second determination unit determines transmittance exhibiting a larger difference from the reference value than the transmittance determined for the present frame by the first determination unit as the transmittance of the first panel in an earlier divided period of two divided periods that constitute the period of the present frame, and
the second determination unit determines the reference value as the transmittance of the first panel in a later divided period of the two divided periods that constitute the period of the present frame.

8. The image-display apparatus according to claim 2, wherein
the first panel is capable of individually controlling the transmittance of each of a plurality of divided regions that constitute a region of an image represented by the input image data,
the divided region is constituted by a plurality of pixels of the input image data,
the first determination unit determines the transmittance of the first panel for each of the pixels of the input image data, and
the image-display apparatus further comprises:
a third determination unit configured to determine the transmittance of the first panel for each of the divided regions, based on the transmittance of the first panel for each of the pixels determined by the first determination unit.

9. The image-display apparatus according to claim 2,
wherein the first determination unit determines the transmittance of the first panel by correcting the reference value.

10. The image-display apparatus according to claim 2, further comprising:
a fourth determination unit configured to determine the reference value based on brightness of the entire screen that a user inputs.

11. A control method for an image-display apparatus having a light emission unit; a first panel configured to transmit light emitted from the light emission unit; and
a second panel configured to display an image on a screen by transmitting the light transmitted through the first panel,
the method comprising:
a first step of controlling the transmittance of the first panel at transmittance based on a time change of the brightness of input image data; and
a second step of controlling the transmittance of the second panel at transmittance based on the input image data.

12. The method according to claim 11, further comprising:
a first determination step of determining the transmittance of the first panel based on the time change of the brightness of the input image data, wherein
in the first determination step, a reference value of the transmittance is determined as the transmittance of the first panel when the brightness of the input image data does not change,
in the first determination step, a value larger than the reference value is determined as the transmittance of the first panel when the brightness of the input image data increases, and
in the first determination step, a value smaller than the reference value is determined as the transmittance of the first panel when the brightness of the input image data decreases.

13. The method according to claim 12, wherein
when the brightness of the input image data increases from a frame immediately preceding a present frame to the present frame, in the first determination step, the transmittance of the first panel for the present frame to be a larger value as amount of increase of the brightness is larger is determined, and
when the brightness of the input image data decreases from the immediately preceding frame to the present frame, in the first determination step, the transmittance of the first panel for the present frame to be a smaller value as amount of decrease of the brightness is larger is determined.

14. The method according to claim 12, wherein
correspondence information that relates to the correspondence between an amount of change of the brightness and the transmittance is provided in advance, and
in the first determination step, the transmittance of the first panel for the present frame is determined based on the brightness of the input image data of the frame immediately preceding the present frame, the brightness of the input image data of the present frame, and the correspondence information.

15. The method according to claim 12,
wherein in the first determination step, the time-differentiation of the brightness of the input image data is performed and the transmittance of the first panel is determined corresponding to a result of the time-differentiation.

16. The method according to claim 13, further comprising:
a second determination step of determining the transmittance of the first panel for each of n divided periods (where n is an integer equal to or greater than 2) that constitute a period of the present frame of the input image data, based on the transmittance determined for the present frame in the first determination step.

17. The method according to claim 16, wherein
when the brightness of the input image data changes, in the second determination step, transmittance exhibiting a larger difference from the reference value than the transmittance determined for the present frame by the first determination step is determined as the transmittance of the first panel in an earlier divided period of two divided periods that constitute the period of the present frame, and
in the second determination step, the reference value is determined as the transmittance of the first panel in a later divided period of the two divided periods that constitute the period of the present frame.

18. The method according to claim 12, wherein
the first panel is capable of individually controlling the transmittance of each of a plurality of divided regions that constitute a region of an image represented by the input image data,
the divided region is constituted by a plurality of pixels of the input image data,
in the first determination step, the transmittance of the first panel is determined for each of the pixels of the input image data, and
the method further comprises:
a third determination step of determining the transmittance of the first panel for each of the divided regions, based on the transmittance of the first panel for each of the pixels determined in the first determination step.

19. The method according to claim 12,
wherein in the first determination step, the transmittance of the first panel is determined by correcting the reference value.

20. The method according to claim 12, further comprising:
a fourth determination step of determining the reference value based on brightness of the entire screen that a user inputs.
